(19) United States
(12) Patent Application Publication
(10) Pub. No.: US 2004/0181758 A1
(43) Pub. Date: Sep. 16, 2004

(54) Text and question generating apparatus and method

(76) Inventors: Satoshi Shinpuku, Kawasaki (JP); Isao Namba, Yokohama (JP)

Correspondence Address: Edward A. Pennington, Swidler Berlin Shereff Friedman, LLP, Suite 300, 3000 K Street, NW, Washington, DC, 20007-5116, US

(21) Appl. No.: 10/798,945

(22) Filed: Mar. 12, 2004

(30) Foreign Application Priority Data
Mar. 14, 2003 (JP) 2003-069658

(51) Int. Cl. G06F 17/00

(52) U.S. Cl. 715/530

(57) ABSTRACT

To extract words or the like intensively related to contents of text from the same text without necessity of cost required for a excessively large amount of man-power and thereby to generate the information of the text using these extracted words or the like. The text information generating method and apparatus comprises an attribute input section for inputting artificial attribute, a discourse structure attribute generating section for generating discourse structure attribute and paragraph length ratio attribute, a combination attribute generating section for generating combination attribute by freely combining artificial attribute, discourse structure attribute and paragraph length ratio attribute, an importance degree estimating section for respectively estimating importance degree indicating enhancement degree of correlation with contents of text for each attribute, a text input interface, an important paragraph determining section for determining the important paragraphs from one or more paragraphs in the input text on the basis of an importance degree of each attribute, and a text output interface for outputting the information of the input text generated on the basis of determination of the important paragraph determining section.

### BACKGROUND OF THE INVENTION

The present invention relates to a method and apparatus for generating text information, for gathering examples based on the generated text, for extracting incidents for generating Frequently Asked Questions (FAQs), and for searching. As an example, in accordance with the present invention, generated can be used to search for predetermined text from a plurality of texts and for gathering examples of such text. Such a search may include a search for the text including words or the like that are is similar in content to the predetermined text (hereinafter, referred to as “words or the like”). Moreover, the clustering of incidents can include identifying text, from a plurality of texts comprising a group, that includes similar designated elements and viewpoints.

When text is searched or examples are gathered, it is important to understand contents of the text within the text group used for searching and clustering of incidents. However, this requires a longer time and much more labor to check the point of all such text. In order to reduce the time and labor required for search and clustering of incidents, information of text has been generated based on techniques such as described below.

In Japanese Published Unexamined Patent Application No. 1996-305710, each word in each text is arranged depending on the ranking order in each text by comparing the appearing frequency of the relevant word in the text group and each text forming the text group prepared for searching and clustering of incidents. Accordingly, the text including designated important word can be searched easily and examples of such texts can also be gathered easily.

In Japanese Published Unexamined Patent Application No. 2002-278977, a discourse structure indicating a class of comment is granted to each word or the like in each text through a discourse structure analysis thereof. By using a discourse structure, words, phrases or the like that can be though to have little relation with contents of text (for example, habitual greetings or the like) can be eliminated from text to be searched. Accordingly, time and labor required for searching text of a text group can be reduced and the searching and clustering of incidents can be done more easily.

Also, a class is granted to each word or the like included in a text group and a database is categorized based on the classes. Since, by employing such classes, text having a word or the like of a class that is similar to a designated word or the like can be categorized from the text having no relevant word or the like, searching and clustering of incidents can be performed more easily. In Japanese Published Unexamined Patent Application No. 2002-24144, the abstract of text can be obtained using a template for forming items of important words in the text. The abstract of each text can be utilized and thereby searching and clustering of incidents can also be realized easily.

The above approaches, however, have several drawbacks that are discussed below with reference to FIG. 23. The group of texts described in FIG. 23 comprises text 1, text 2, and text 3. Text 1 is similar to text 2 in the use of characters. This is because, for example, text 1 and text 2 are have common text such as the characters “training” and “duck” are used). Text 1 is also similar to text 3 because, for example, the text 1 and text 3 have common text such as “cooking.”

A drawback with the technique outlined in Japanese Published Unexamined Patent Application No. 1996-305710 is that only the text that is similar in the use of characters to the designated word or the like can be determined easily by utilizing the ranking order of the word in the text. But, the text similar in content to the designated word or the like cannot be determined easily. For example, FIG. 23, there is a problem, for example, that since rare words such as “training” and “duck” are used in both text 1 and 2, it is not easy, even when a ranking order generated is introduced, to find the text 3, which is similar to the text 1 as the text similar to the text 1.

Moreover, with Japanese Published Unexamined Patent Application No. 2002-278977, since extra words or the like can be eliminated only to a certain degree even when a discourse structure is used, importance is placed to a certain degree on the similarity in the use of the other characters and the text which is similar in content cannot always be determined easily. Namely, in FIG. 23, there exists higher possibility that it is not easy to find the text 3 that is similar in content to the text of text 1, even when discourse structure related to this publication is utilized.

In addition, Japanese Published Unexamined Patent Application No. 2002-278977 has the problem that the text including the word or the like which is common in the use of characters to the designated word or the like but is different in the class cannot be determined easily even when the class information granted to the word is used and thereby the text 3 similar in content to the text 1 cannot be determined easily as the text similar to the text 1, for example, in FIG. 23. In Japanese Published Unexamined Patent Application No. 2002-24144, extraordinary cost is required to generate model of template used to extract contents from the text and condition to fill each template in the case of generating an abstract of the text where various expressions such as comment are mixed. Also, the template cannot be used, if the template is previously generated.

As described above, the information generated by the prior art is insufficient when used as the information to find the text that are similar in content in the case of searching the text and clustering the incidents of text.

Accordingly, it has been extremely important problem, for example, in FIG. 23 to find the text 3 similar in content to the text 1 as the text similar to the text 1.

### SUMMARY OF THE INVENTION

It is often important to find the text having the contents identical to that of a designated word or the like or the text having the contents similar to that of the designated word or the like, in the searching and clustering of incidents, than the finding out of the text having the common vector of the text itself.

Considering the background described above, it is an object of the present invention to provide a text information generating method and apparatus that can extract the words or the like intensively related to contents of the text without requirement of cost to be consumed for excessively large amount of man-power, and can generate information of the text using the extracted words or the like, an incident clustering method and apparatus utilizing the information of text generated by the text information generating apparatus, a question example extracting apparatus for generating FAQ (Frequently Asked Questions), and a searching apparatus.

According to one embodiment of the present invention, a text information generating apparatus can comprise, for example, an attribute input section, a discourse structure attribute generating section, a combination attribute generating section, an importance degree estimating section, a text input interface, an important paragraph determining section and a text output interface. In an example of the present invention, the attribute input section inputs artificial attribute generated by a user and granted to paragraph as a part of document or sentence. In an example of the present invention, the discourse structure attribute generating section generates discourse structure attribute related to discourse structure granted to the paragraph and paragraph length ratio attribute related to a ratio of the number of characters of the paragraph to the number of characters of a matching pattern matched with the paragraph. The combination attribute section, in an example of the present invention, generates combination attribute attained by freely combining artificial attribute inputted to the attribute input section, discourse structure attribute and paragraph length ratio attribute generated with the discourse structure attribute generating section. In addition, an exemplary importance degree estimating section estimates an importance degree indicating an enhancement degree of correlation between the paragraph and text when the artificial attribute inputted to the attribute input section, discourse structure attribute and paragraph length ratio attribute generated with the discourse structure attribute generating section, and combination attribute generated with the combination attribute generating section are granted to the paragraph. Moreover, the text input interface inputs text. An illustrative important paragraph determining section determines, for example, on the basis of the importance degree of each attribute estimated with the importance degree estimating section, important paragraph having higher correlation with contents of text inputted to the text input interface from one or more paragraphs in the text inputted to the text input interface. In addition, the text output interface outputs information of the text inputted to the text input interface generated on the basis of determination with the important paragraph determining section.

Another aspect of the present invention relates to an text information generating method and apparatus. The text information generating method and apparatus of the second invention comprises, for example an attribute input section, a discourse structure attribute generating section, a word attribute generating section, a combination attribute generating section, an importance degree estimating section, a text input interface, an important paragraph determining section, and a text output interface. In an example of the present invention, the attribute input section inputs artificial attribute generated with a user and granted to paragraph as a part of document or sentence. Moreover, an exemplary discourse structure attribute generating section generates, for example, discourse structure attribute related to discourse structure granted to the paragraph and paragraph length ratio attribute related to a ratio of the number of characters of paragraph to the number of characters of a matching pattern matched with the paragraph. In addition, an illustrative word attribute generating section generates word attribute related to words. And, an example combination attribute generating section generates combination attribute attained by freely combining artificial attribute inputted to the attribute input section, discourse structure attribute and paragraph length ratio attribute generated with the discourse structure attribute generating section, and word attribute generated with the word attribute generating section. Moreover, the importance degree estimating section estimates, in an embodiment of the present invention, an importance degree indicating an enhancement degree of correlation between the paragraph and text when artificial attribute inputted to the attribute input section, discourse structure attribute and paragraph length ratio attribute generated with the discourse structure attribute generating section, word attribute generated with the word attribute generating section, and combination attribute generated with the combination attribute generating section are granted to the paragraph. The text input interface inputs text; and the important paragraph determining section determines, for example, from one or more paragraphs in the text inputted to the text input interface, important paragraph having higher correlation with contents of the text inputted to the text input interface on the basis of an importance degree of each attribute estimated with the importance degree estimating section. An illustrative text output interface outputs information of the text inputted to the text input interface generated on the basis of determination with the important paragraph determining section.

Another of the present invention relates to a text information generating method and apparatus that comprises, for example an attribute input section, a discourse structure attribute generating section, a combination attribute generating section, an importance degree estimating section, an extra attribute deleting section, a text input interface, an important paragraph determining section, and a text output interface. The attribute input section can input, for example, artificial attribute generated with a user. An exemplary discourse structure attribute generating section generates discourse structure attribute related to discourse structure and granted to the paragraph and paragraph length ratio attribute related to a ratio of the number of characters of the paragraph to the number of characters of a matching pattern matched with the paragraph. The combination attribute generating section generates, for example, combination attribute attained by freely combining artificial attribute inputted to the attribute input section, discourse structure attribute and paragraph length ratio attribute generated with the discourse structure attribute generating section. An illustrative importance degree estimating section estimates an importance degree indicating an enhancement degree of correlation between the paragraph and text when artificial attribute inputted to the attribute input section, discourse structure attribute and paragraph length ratio attribute generated with the discourse structure attribute generating section, and combination attribute generated with the combination attribute generating section are granted to the paragraph. Also, an example surplus attribute deleting section deletes the determined surplus attribute from each attribute of which importance degree is estimated with the importance degree estimating section. An text input interface inputs text; and an important paragraph determining section determines, for example, from one or more paragraphs in the text inputted to the text input interface, important paragraph having higher correlation with contents of the text inputted to the text input interface on the basis of the importance degree estimated with the importance degree estimating section of the attribute not erased with the surplus attribute deleting section. And finally, an example text output interface outputs information of the text inputted to the text input interface generated on the basis of determination of the important paragraph determining section.

Another aspect of the invention relates to a text information generating method and apparatus wherein information of the text outputted from a text output interface is abstract sentence formed based the important paragraph determined with the important paragraph determining section.

Still another aspect of the present invention relates to an incident clustering method and apparatus. An embodiment of the incident clustering apparatus of the present invention includes a section where a plurality of texts describing the predetermined contents are clustered by utilizing the information outputted from the text output interface of any of the text information generating apparatus summarized above.

A further aspect of the present invention relates to a question example extracting method and apparatus for generating FAQ (Frequently Asked Questions). An example question example extracting apparatus for generating FAQ includes a section that sorts a plurality of question examples to at least one gathering of question examples by utilizing an incident clustering apparatus as summarized above, determining a gathering of question examples including the question example which can be assumed to be asked in future from at least one gathering of question examples, and outputting question examples included in the determined gathering of question examples.

Another aspect of the present invention relates to a searching method and apparatus. An example searching apparatus searches text describing the predetermined contents from a group of texts by utilizing information outputted from an text output interface such as summarized above.

In the above summaries, the each of the mentioned exemplary sections performs the described illustrative actions that comprise aspects of the method of the present invention.

### BRIEF DESCRIPTION OF THE DRAWINGS

FIG. 1 is a schematic diagram of a text information generating apparatus in accordance with an embodiment of the present invention.

FIG. 2 illustrates a flowchart for describing the processes executed in the text information generating apparatus in relation to an embodiment of the present invention.

FIG. 3 illustrates a flowchart for describing the pre-process executed in step S2-1 of FIG. 2.

FIG. 4 illustrates a flowchart for describing generation of attributes forming the initial attribute set in step S3-1 of FIG. 3.

FIG. 5 is a flowchart for describing the process to generate word attribute with the word attribute generating section to be executed in step S3-4 of FIG. 3.

FIG. 6 is a flowchart for describing the process by the surplus attribute deleting section to be executed in step S3-8 of FIG. 3.

FIG. 7 illustrates a flowchart for describing the final check to be executed in step S3-7 of FIG. 3.

FIG. 8 illustrates a flowchart for describing the process of the importance degree estimating section executed in step S5-4 of FIG. 5.

FIG. 9 illustrates a flowchart for describing the process with the important paragraph determining section.

FIG. 10 schematically illustrates example content of a discourse structure rule database.

FIG. 11 schematically illustrates example content of an attribute set database.

FIG. 12 schematically illustrates example content of a database utilized in an embodiment of the present invention.

FIG. 13 schematically illustrates example content of result database utilized in an embodiment of the present invention.

FIG. 14 schematically illustrates example content showing attributes of text in accordance with an aspect of an embodiment of the present invention.

FIG. 15 illustrates example text employed in the discussion of the embodiments of the present invention.

FIG. 16 schematically illustrates example text tagged and describing a kind of discourse structure.

FIG. 17 schematically illustrates an example of text generated in accordance with an embodiment of the present invention FIG. 18 schematically illustrates another example of text generated in accordance with an embodiment of the present invention.

FIG. 19 schematically illustrates paragraphs and an importance degree in an example in accordance with the present invention when a word attribute is not added.

FIG. 20 schematically illustrates paragraphs and an importance degree in another example of the present invention when a word attribute is added.

FIG. 21 schematically illustrates paragraphs and an importance degree in an example in accordance with the present invention using surplus inclusion attribute set when a word attribute is not deleted.

FIG. 22 schematically illustrates paragraphs and an importance degree in an example in accordance with the present invention using surplus inclusion attribute set when a word attribute is deleted.

FIG. 23 illustrates example text used in the discussion of embodiments of the present invention.

### DETAILED DESCRIPTION OF THE PREFERRED EMBODIMENTS

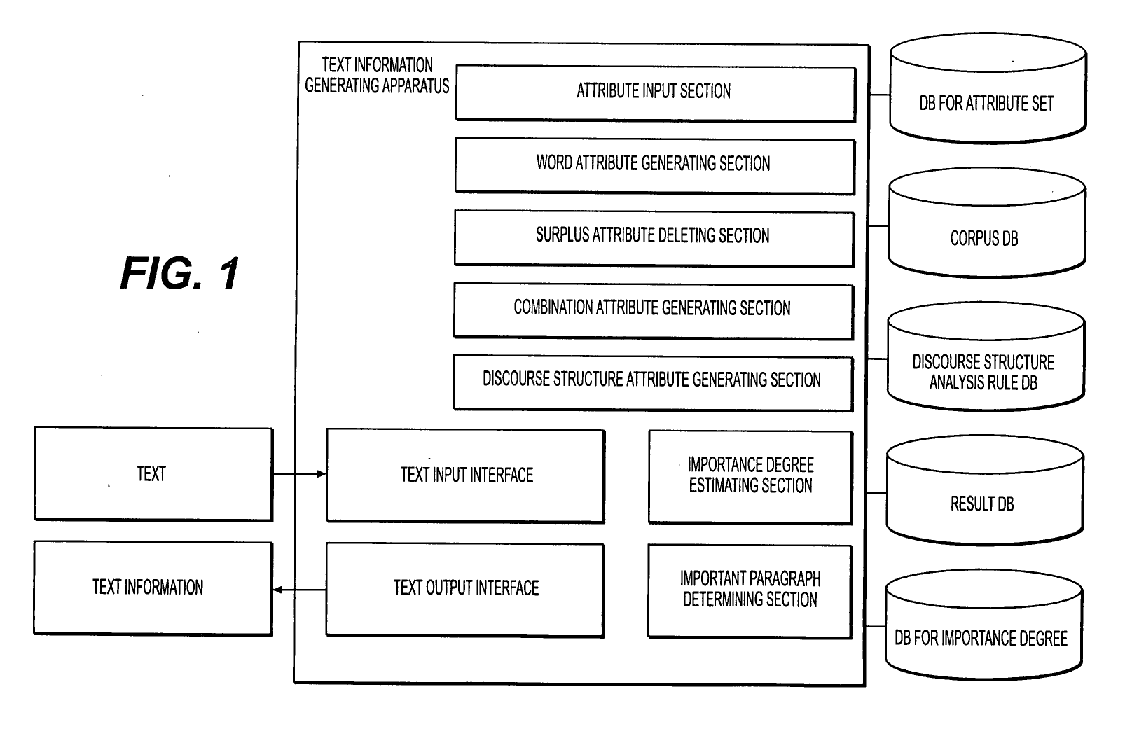

Referring to FIG. 1, a text information generating apparatus in accordance with an embodiment of the present invention comprises, for example, an attribute input section, a word attribute generating section, a surplus attribute deleting section, a combination attribute generating section, a discourse structure attribute generating section, an importance degree estimating section, an important paragraph determining section, a text input interface, and a text output interface.

Moreover, the text information generating apparatus of this embodiment of the present invention communicates with an attribute set database (“DB”), a corpus DB, a discourse structure analysis rule DB, a result DB, and an importance degree DB. Here, DB is an abbreviation of database. Moreover, the corpus means a language sample body and texts are stored in large scale or in total-inclusive manner in the corpus DB.

The text information generating apparatus of this embodiment of the present invention generates information based on text inputted from the text input interface and outputs generated information from the text output interface.

Here, information of text means, for example, an abstract sentence of the information and text in which the important areas in the text are displayed with emphasis.

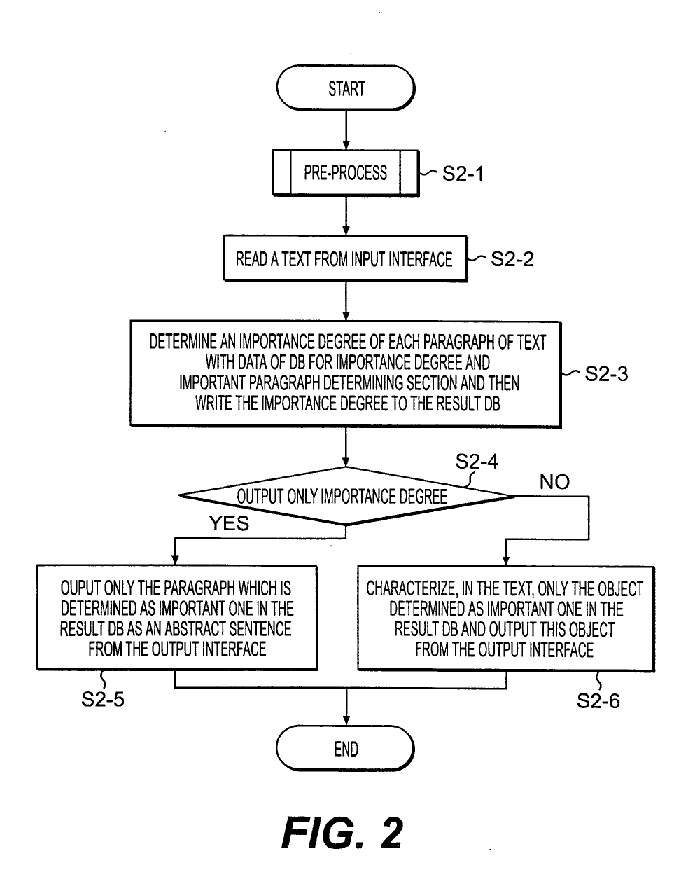

FIG. 2 illustrates a flowchart for describing the processes executed in the text information generating apparatus in relation to the embodiment of the present invention. First, a pre-process is executed in the text information generating apparatus of the embodiment of the present invention (step S2-1).

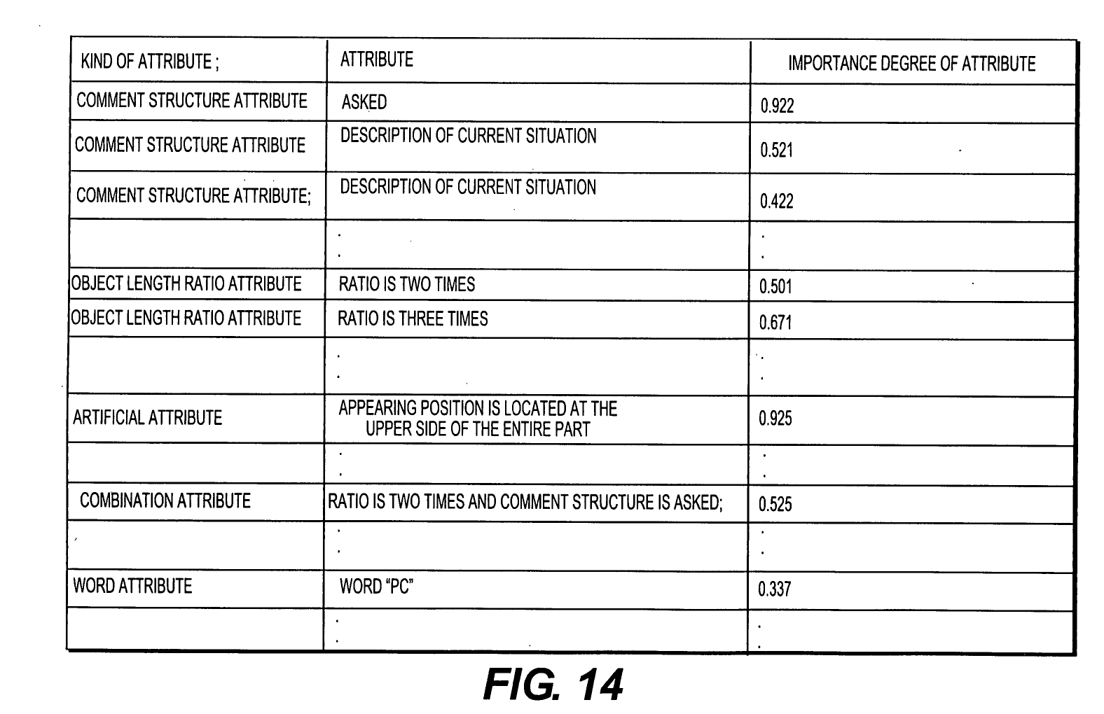

Here, the pre-process comprises, for example, a processes for generating and inputting at least one attribute which may be granted to a paragraph (a part of sentences or a part of sentence forming these sentences described in the text), estimating an importance degree of the attribute generated or inputted, and writing corresponding relationship between the attribute generated or inputted and an importance degree of this attribute generated or inputted to DB for importance degree of attribute, some of the content of which is schematically shown in FIG. 14.

As will be apparent from above description, in the preferred embodiment attributes are a set of attributes formed at least of one attribute. Moreover, attribute refers to, for example, feature or characteristic granted to paragraph with the text information generating apparatus.

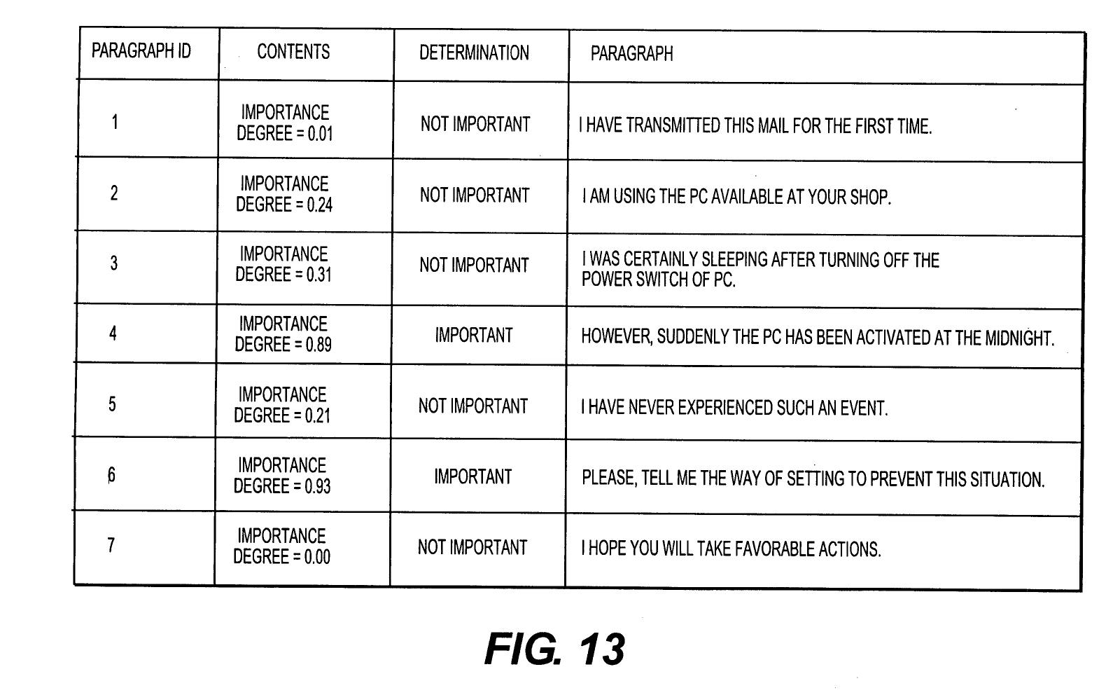

Next, the text information generating apparatus in relation to the embodiment of the present invention reads the text inputted from the text input interface of FIG. 1 (step S2-2). The text information generating apparatus in relation to the embodiment of the present invention then estimates an importance degree of each paragraph forming the text read in step S2-2, determines whether each paragraph is important or not depending on the estimated importance degree of each paragraph, and writes the paragraph, importance degree of the paragraph, and importance or non-importance of the paragraph into the result DB, some of the content of which is schematically shown in FIG. 13 (step S2-3).

Next, the text information generating apparatus in relation to the embodiment of the present invention determines whether only the paragraph which is determined as the important paragraph in the result DB of FIG. 13 should be outputted or not from the text output interface (step S2-4).

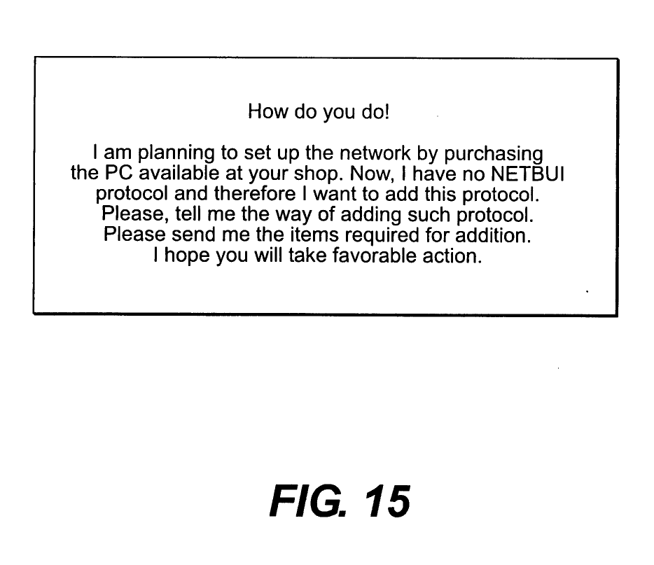

When it is determined in step S2-4 that only the paragraph (important paragraph) which is determined as the important paragraph should be outputted, the text information generating apparatus in relation to the embodiment of the present invention outputs an abstract sentence indicating the paragraph determined as an important paragraph from the output interface (step S2-5). For example, when the text described in FIG. 15 is read in step S2-5, the text information generating apparatus in relation to the embodiment of the present invention outputs the text described in, for example, FIG. 17.

On the other hand, when it is determined in step S2-4 that only the paragraph (important paragraph) determined as the important paragraph should not be outputted, the text information generating apparatus in relation to the embodiment of the present invention outputs the text in which the determined important paragraph is displayed with emphasis (step S2-6). For example, when the text described in FIG. 15 is read in step S2-5, the text information generating apparatus in relation to the embodiment of the present invention outputs the text described in, foe example, FIG. 18.

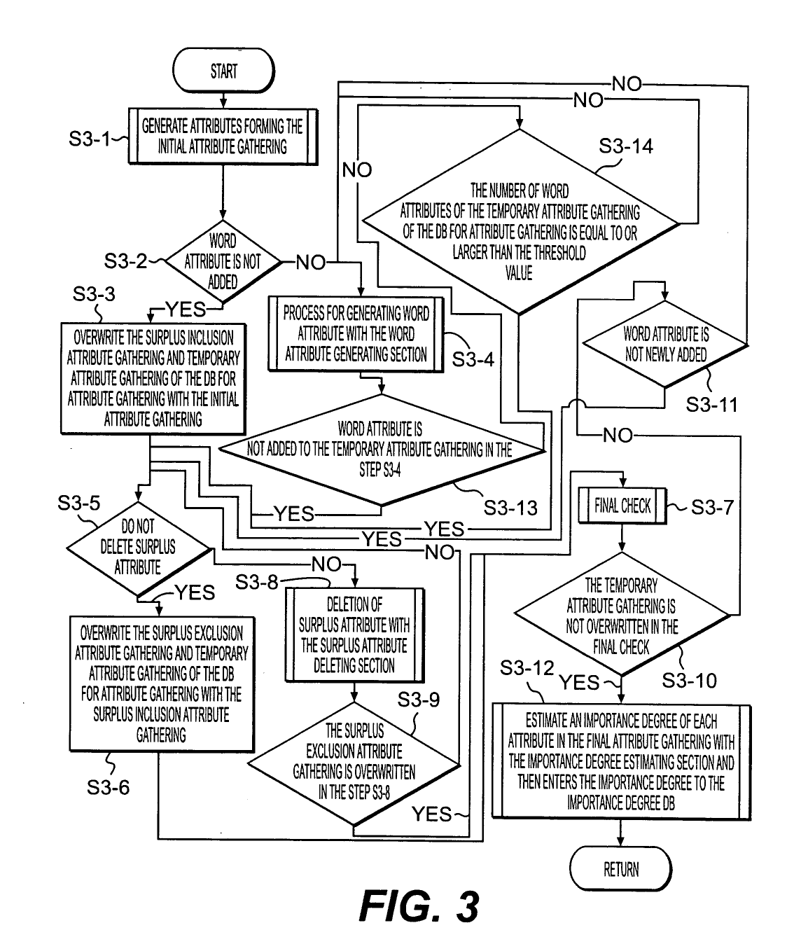

FIG. 3 illustrates a flowchart for describing an example of the pre-process executed in step S2-1 of FIG. 2. Pre-processing includes, for example, the text information generating apparatus in relation to an embodiment of the present invention generating first at least one attribute as the attribute forming an initial attribute set (step S3-1). Next, it is determined whether a word attribute should be added or not to the initial attribute set (step S3-2). That determination can be performed in a text information generating apparatus in accordance with the present invention.

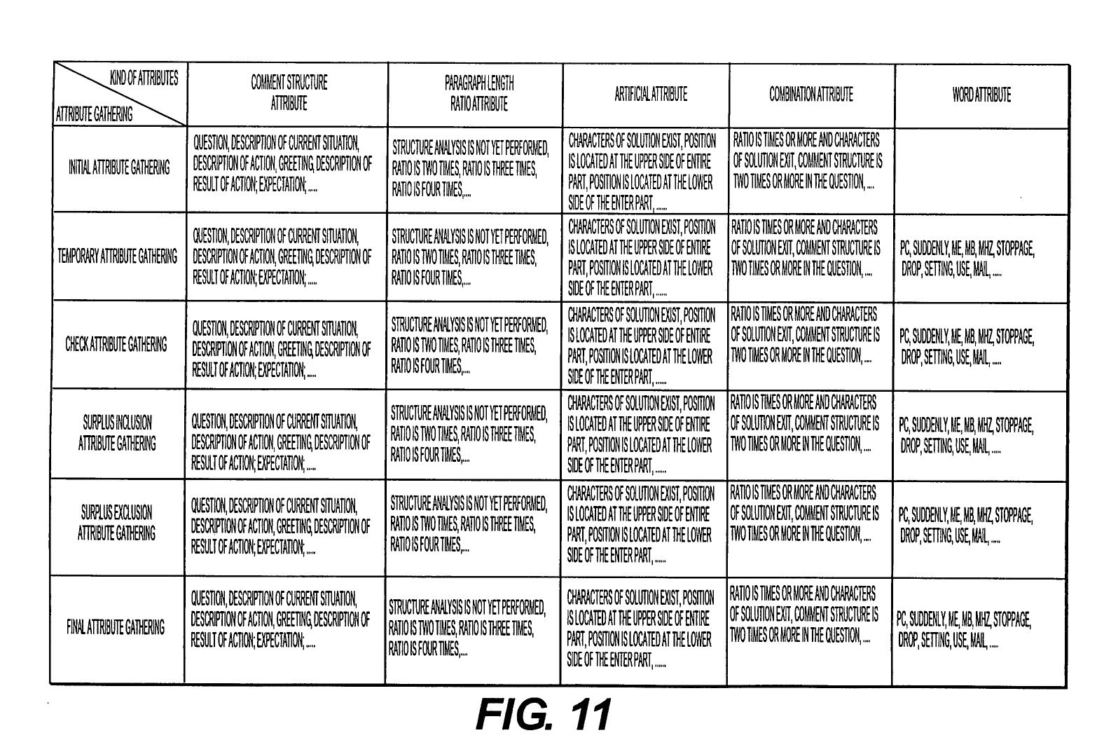

When it is determined in step S3-2 that a word attribute is not added to the initial attribute set, temporary attribute set and surplus exclusion attribute set of the DB for attribute set of FIG. 11 are overwritten with the initial attribute set (step S3-3).

On the other hand, when it is determined in step S3-2 that a word attribute is added, the text information generating apparatus in relation to the embodiment of the present invention, as an example, executes the process to generate word attribute with the word attribute generating section (step S3-4).

When the process to generate a word attribute with the word attribute generating section in step S3-4 is performed, it is determined with the text information generating apparatus in relation to the embodiment of the present invention in step S3-4 whether word attribute is added to the temporary attribute set of DB for attribute set of FIG. 11 (step S3-13).

When it is determined in step S3-13 that a word attribute is added to the temporary attribute set, the text information generating apparatus in relation to an embodiment of the present invention determines whether the number of word attributes forming the temporary attribute set of DB for attribute set of FIG. 11 is equal to or larger than the threshold value (step S3-14).

When the number of word attributes is determined to be lower than the threshold value in step S3-14, the text information generating apparatus, for example, returns to step S3-4 to execute the process to generate word attribute with the word attribute generating section.

On the other hand, when the number of word attributes is determined to be equal to or larger than the threshold value in step S314, the text information generating apparatus, for example, performs the process of the step S3-5.

When it is determined in step S3-13 that a word attribute is not added to the temporary attribute set, the text information generating apparatus in accordance with the present invention executes the process of step S3-5. Next, the text information generating apparatus in relation to the embodiment of the present invention determines whether surplus attribute should be erased or not (step S3-5).

When it is determined in step S3-5 that a surplus attribute should not be erased, surplus exclusion attribute set and temporary attribute set stored in the DB for attribute set of FIG. 11 are overwritten with surplus inclusion attribute set in the text information generating apparatus in relation to the embodiment of the present invention (step S3-6). When overwriting is performed in step S3-6, the exemplary text information generating apparatus in accordance with the present invention performs a final check (step S3-7).

On the other hand, when a surplus attribute is determined to be erased in step S3-5, surplus attribute is erased with the surplus attribute deleting section in, for example, the text information generating apparatus in accordance with the present invention (step S3-8). When a surplus attribute is erased in step S3-8, the text information generating apparatus in relation to the embodiment of the present invention determines whether surplus exclusion attribute set is overwritten or not in step S3-8 (step S3-9).

When it is determined in step S3-9 that surplus attribute set is not overwritten, the text information generating apparatus in relation to the embodiment of the present invention returns to step S3-5 to repeat the process of this step. On the other hand, when it is determined in step S3-9 that surplus exclusion attribute set is overwritten, the text information generating apparatus in relation to the embodiment of the present invention performs a final check (step S3-7).

When the final check in step S3-7 is terminated, the text information generating apparatus in relation to the embodiment of the present invention determines whether temporary attribute set of the DB for attribute set of FIG. 11 is overwritten or not with the final check in step S3-7 (step S3-10).

When it is determined in step S3-10 that temporary attribute set is overwritten, the text information generating apparatus in relation to the embodiment of the present invention determines whether word attribute should be newly added or not (step S3-11). When word attribute is determined to be newly added in step S3-11, the processing returns to step S3-4 to execute the process to generate word attribute with the word attribute generating section.

On the other hand, when a word attribute is determined not to be newly added in step S3-11, the processing returns to step S3-5 to determine whether surplus attribute should be erased or not. When it is determined in step S3-10 that temporary attribute set is not overwritten, the importance degree estimating section estimates an importance degree of each attribute forming the final attribute set of the DB for attribute set of FIG. 11. This estimated importance degree is written into the importance degree DB as schematically shown of FIG. 14 (step S3-12).

When importance degree of each attribute is estimated and the estimated importance degree is written into the importance degree DB of FIG. 14 in step S3-12, the text information generating apparatus in relation to the embodiment of the present invention terminates the pre-process of the step S2-1 of FIG. 2.

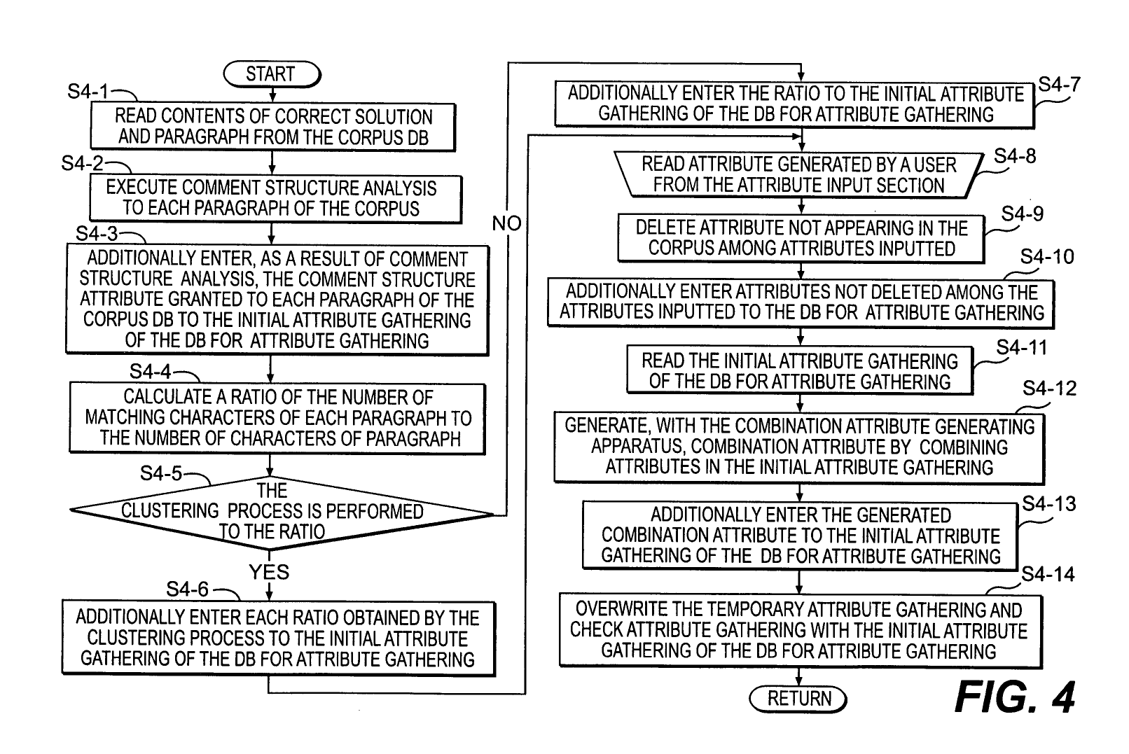

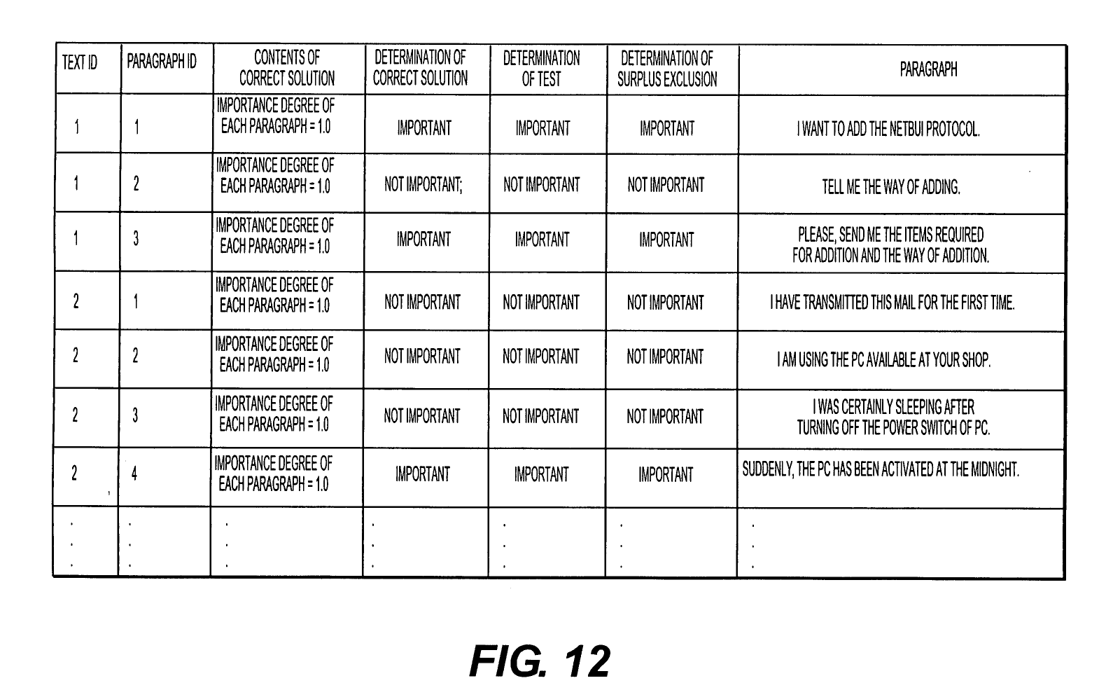

FIG. 4 illustrates a flowchart for describing generation of attributes forming the initial attribute set in step S3-1 of FIG. 3. When attributes forming the initial attribute set are generated, the text information generating apparatus in relation to the embodiment of the present invention paragraph from the corpus DB of FIG. 12 (step S4-1). Next, the text information generating apparatus analyzes discourse structure with the discourse structure attribute generating section for paragraphs read from the corpus DB (step S4-2).

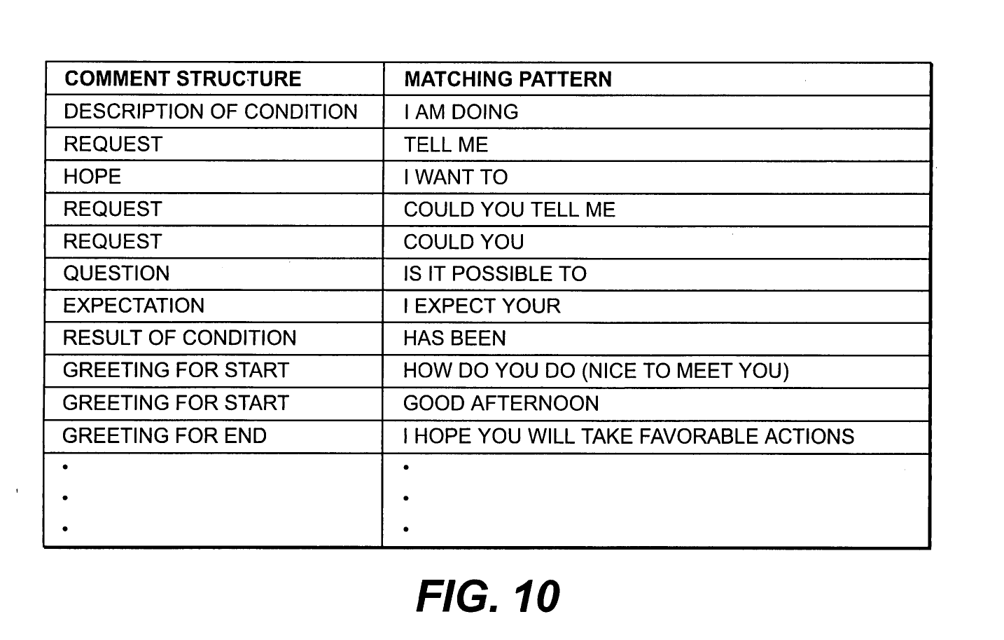

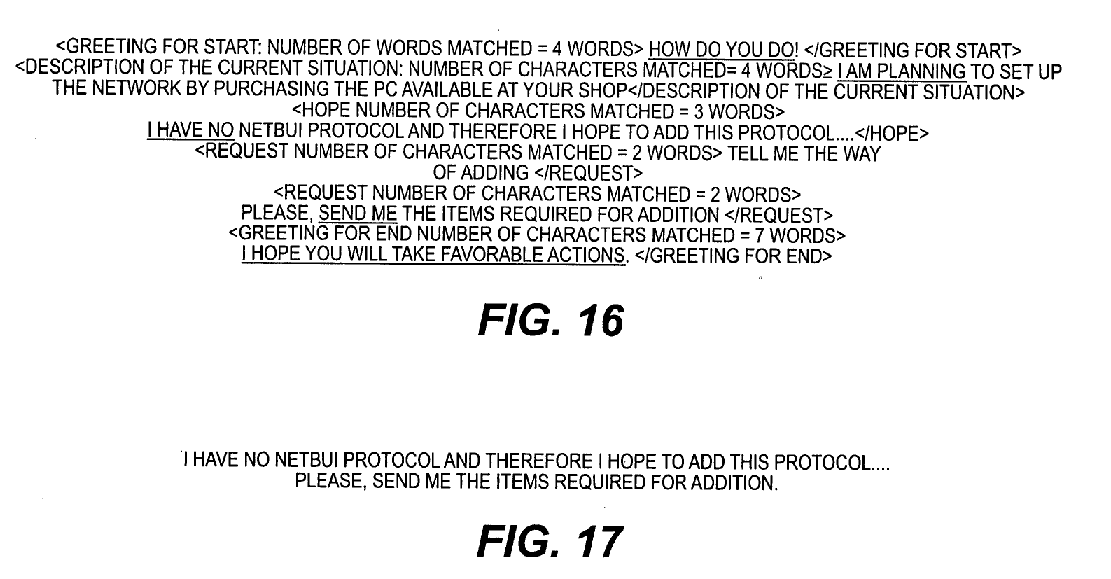

In the above mentioned example discourse structure analysis, matching is preferably executed first between the matching pattern of the discourse structure analysis rule DB and each paragraph forming the text. In one example, the matching pattern of the discourse structure analysis rule DB is generated previously. When the matching pattern of the discourse structure analysis rule DB, which is schematically shown in FIG. 10, is matched with a paragraph, the matched paragraph is determined as the discourse structure corresponding to the matched matching pattern and a comment tag indicating the determined discourse structure and number of words matched (number of characters of matching pattern) is granted to each paragraph. According to this discourse structure analysis, when the text illustrated in FIG. 15 is inputted to the discourse structure attribute generating section, the text illustrated in FIG. 16 is outputted.

When two matching patterns are matched in the same area of one paragraph, priority is given to the matching pattern described in the highly ranked area of the discourse structure rule DB; some of the content of which is schematically shown in FIG. 10. Therefore, in this example, a plurality of discourse structures are not granted to the same area of one paragraph. For example, when the matching patterns “Could you tell me . . . ” and “Could you . . . ” of the discourse structure rule DB of FIG. 10 are matched in a certain paragraph, priority is given to the match pattern “Could you tell me . . . ” described in the highly ranked area in the discourse structure rule DB of FIG. 1. Accordingly, the match pattern “Could you . . . ” is assumed to be matched with one paragraph. However, if the match pattern is given in the form of “although . . . , . . . impossible”, it is possible to give the discourse structure matched with “although . . . ” and the discourse structure matched with “ . . . impossible” to the different portions of one paragraph.

Next, the discourse structures granted respectively to the paragraphs of the corpus DB of FIG. 12 are written, as discourse structure attribute, into the initial attribute set in the DB for attribute set of FIG. 11 (step S4-3). This can be performed in, for example, the text information generating apparatus in relation to the embodiment of the present invention.

Next, in the text information generating apparatus in relation to the embodiment of the present invention, a ratio of the number of words in each matching granted to each paragraph of the corpus DB of FIG. 12 to the number of words of paragraph stored in the corpus DB of FIG. 12 is calculated (step S4-4). This can be performed in, for example, the text information generating apparatus in relation to the embodiment of the present invention.

Next, it is determined whether the clustering process (for example, the process to express a ratio of the adjacent numerical values having the same integer unit with one ratio) should be executed or not for each calculated ratio (step S4-5). This can be performed in, for example, the text information generating apparatus in relation to the embodiment of the present invention.

In the text information generating apparatus in relation to the embodiment of the present invention, a determination for execution of the clustering process in step S4-5 can be made. This determination can be made, for example, on the basis of the determination whether a problem of data sparseness (the problem that the data which may be used for the machine learning described later is too thin) is generated or not. When it is determined in step S4-5 that the clustering process is to be performed to each ratio, the clustering process is executed to each ratio and each ratio after the clustering process is written to the initial attribute set in the DB for attribute set of FIG. 11 as the paragraph length ratio attribute in the text information generating apparatus in relation to the embodiment of the present invention (step S4-6).

On the other hand, when it is determined in step S4-5 that the clustering process is not performed for each ratio, a ratio of the number of words of matching to the number of words of paragraph calculated for each paragraph is written, as the paragraph length ratio attribute, to the initial attribute set in the DB for attribute set of FIG. 11. This can be performed by, for example, in the text information generating apparatus in relation to the embodiment of the present invention (S4-7).

When paragraph length ratio attribute is written in the initial attribute set in the DB for attribute set of FIG. 11 in step S4-6 or S4-7, attribute generated by a user is read through the attribute input section in the text information generating apparatus in relation to the embodiment of the present invention (step S4-8). A user is capable of freely generating and inputting the desired word and sentence as attribute.

Next, the attribute not appearing in the corpus DB of FIG. 12 among the attributes read via the attribute input section is deleted (S49). This can be performed in, for example, the text information generating apparatus in relation to the embodiment of the present invention. Next, the text information generating apparatus in relation to the embodiment of the present invention writes, as artificial attribute, attribute not erased in step S4-9 among the attributes read through the attribute input section to the initial attribute set in the DB for attribute set of FIG. 11 (step S4-10).

Next, the initial attribute set of the DB for attribute set (step S4-11) is read. This can be performed in, for example, the text information generating apparatus in relation to the embodiment of the present invention. Next, an attribute attained by combining two or more attributes in the initial attribute set of the DB for attribute set of FIG. 11 is generated as combination attribute (step S4-12). This can be performed in, for example, the text information generating apparatus in relation to the embodiment of the present invention.

For example, when paragraph length ratio attribute “a ratio is two times or more” and artificial attribute “there are characters of solution” are combined, combination attribute “a ratio is two times or more and there are characters of solution” can be generated. Moreover, for example, discourse structure attribute “discourse structure is question” and paragraph length ratio attribute “a ratio is two times or less” are combined, combination attribute “discourse structure is question and a ratio is two times or less” is generated.

Next, combination attribute generated in step S4-12 is written to the initial attribute set of the DB for attribute set of FIG. 11 (step S413). This can be performed in, for example, the text information generating apparatus in relation to the embodiment of the present invention. Next, temporary attribute set and check attribute set are overwritten with the initial attribute set in the DB for attribute set of FIG. 11 (step S4-14). This can be performed in, for example, the text information generating apparatus in relation to the embodiment of the present invention.

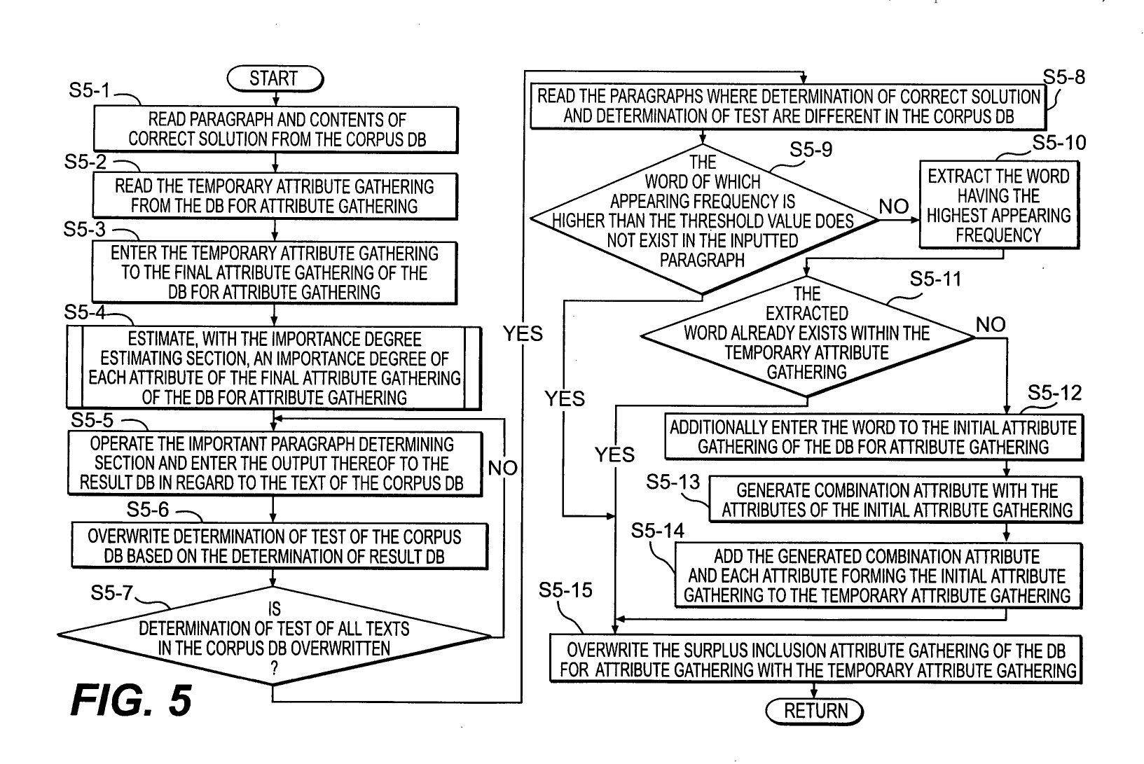

FIG. 5 is a flowchart for describing the process to generate word attribute with, for example, the word attribute generating section to be executed in step S3-4 of FIG. 3. For the process to generate word attribute with, for example, the word attribute generating section, the text information generating apparatus in relation to the embodiment of the present invention reads first, with the word attribute generating section, paragraph and contents of correct solution from the corpus DB of FIG. 12 (step S5-1). Next, the word attribute generating section reads temporary attribute set in the DB for attribute set of FIG. 11 (step S5-2). This can be performed in, for example, the text information generating apparatus in relation to the embodiment of the present invention.

Next, the final attribute set in the DB for attribute set of FIG. 11 is overwritten with the input temporary attribute set in the word attribute generating section (step S5-3). This can be performed in, for example, the text information generating apparatus in relation to the embodiment of the present invention. Next, an importance degree of each attribute forming the final attribute set of the DB for attribute set of FIG. 11 is estimated with the importance degree estimating section (step S5-4). This can be performed in, for example, the text information generating apparatus in relation to the embodiment of the present invention.

Next, an importance degree is determined for each paragraph stored in the corpus DB of FIG. 12 and result of this determination is written into the result DB of FIG. 13 (S5-5). This can be performed in, for example, the text information generating apparatus in relation to the embodiment of the present invention. Next, a determination of test of the corpus DB of FIG. 12 is overwritten with determination of the result DB of FIG. 13 (step S5-6). This can be performed in, for example, the text information generating apparatus in relation to the embodiment of the present invention. This is followed in the preferred embodiment by, in step S5-6, a determination of whether all test results of the corpus DB of FIG. 12 are overwritten or not (step S5-7). This can be performed in, for example, the text information generating apparatus in relation to the embodiment of the present invention.

When it is determined in step S5-7 that all test results of the corpus DB of FIG. 12 are not yet overwritten, the processing returns to step S5-5. On the other hand, when it is determined in step S5-7 that all test results of the corpus DB of FIG. 12 are overwritten, all paragraphs in which determination of correct solution and test determination different from the corpus DB of FIG. 12 (step S5-8) are read. This can be performed in, for example, the text information generating apparatus in relation to the embodiment of the present invention.

Next, a determination is made whether there is a word appearing in the frequency higher than the threshold value in all paragraphs read in or not (step S5-9). This can be performed in, for example, the text information generating apparatus in relation to the embodiment of the present invention. When it is determined in step S5-9 that there is no word appearing in the frequency equal to or higher than the threshold value, the surplus inclusion attribute set is overwritten with the temporary attribute set of DB for attribute set of FIG. 11 (step S5-15). This can be performed in, for example, the text information generating apparatus in relation to the embodiment of the present invention. On the other hand, when it is determined in step S5-9 that there is a word appearing in the frequency equal to or higher than the threshold value, the word having the highest frequency is extracted from the words appearing in the frequency equal to or higher than the threshold value (step S5-10). This can be performed in, for example, the text information generating apparatus in relation to the embodiment of the present invention.

Next, it is determined whether the word extracted in step S5-10 already exists in the temporary attribute set of the DB for attribute set of FIG. 11 or not (step S5-11). This can be performed in, for example, the text information generating apparatus in relation to the embodiment of the present invention. When it is determined in step S5-11 that the word extracted in steps S5-10 already exists in the temporary attribute set of the DB for attribute set of FIG. 11, the surplus inclusion attribute set is overwritten with the temporary attribute set of the DB for attribute set (step S5-15). This can be performed in, for example, the text information generating apparatus in relation to the embodiment of the present invention.

On the other hand, when it is determined in step S5-11 that the word extracted in step S5-10 does not yet exist in the temporary attribute set of the DB for attribute set of FIG. 11, the extracted word is additionally written to the initial attribute set in the DB for attribute set of FIG. 11 (step S5-12). This can be performed in, for example, the text information generating apparatus in relation to the embodiment of the present invention. Next, each attribute forming the initial attribute set of the DB for attribute set of FIG. 11 is combined with the combination attribute generating section and thereby combination attribute is generated (step S5-13). This can be performed in, for example, the text information generating apparatus in relation to the embodiment of the present invention. This is followed, in the illustrative example, by an attribute not included in the temporary attribute set among each attribute forming the initial attribute set of the DB for attribute set of FIG. 11 and attribute not included in the temporary attribute set among combination attributes generated in step S5-13 being additionally added to the temporary attribute set of the DB for attribute set of FIG. 11 (step S5-14). This can be performed in, for example, the text information generating apparatus in relation to the embodiment of the present invention. Next, the surplus inclusion attribute set is overwritten with the temporary attribute set of the DB for attribute set of FIG. 11 (step S5-15).

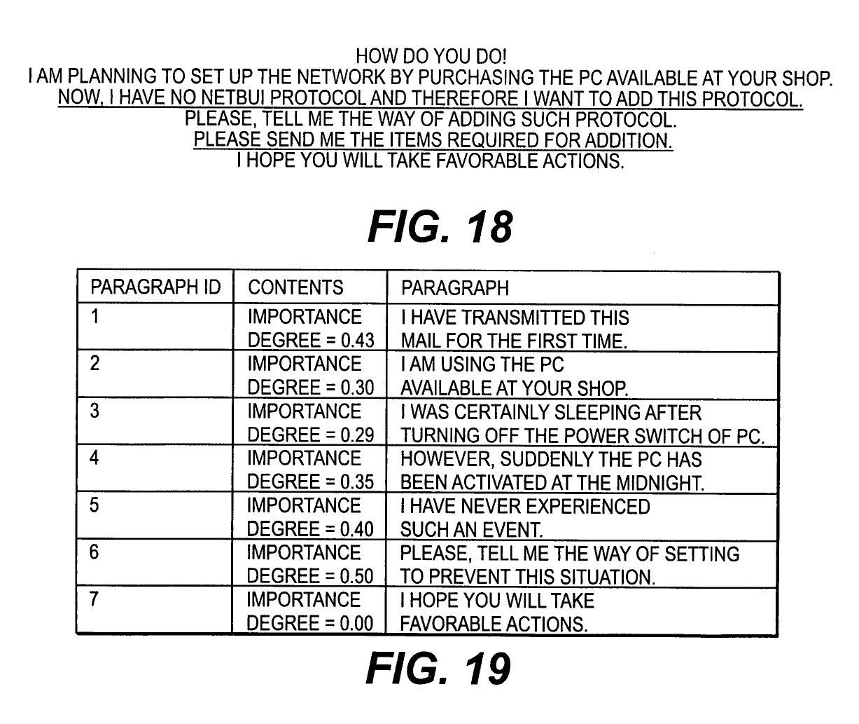

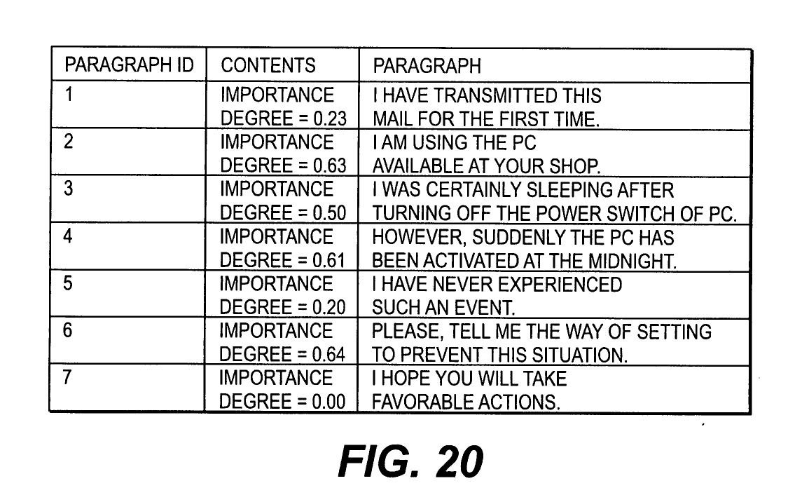

FIG. 19 is a diagram illustrating each paragraph and each importance degree when the text of the text ID=2 in the corpus DB is inputted to the importance degree determining device using the initial attribute set which is the attribute set when word attribute is not added. FIG. 20 is a diagram illustrating each paragraph and each importance degree when the text of the text ID=2 in the corpus is inputted to the importance degree determining device using the attribute set when word attribute is added. As is apparent from FIG. 19 and FIG. 20, it can be understood that the paragraph having the second highest importance degree is also changed and increased in the accuracy because attributes of word such as PC, suddenly and setting are added.

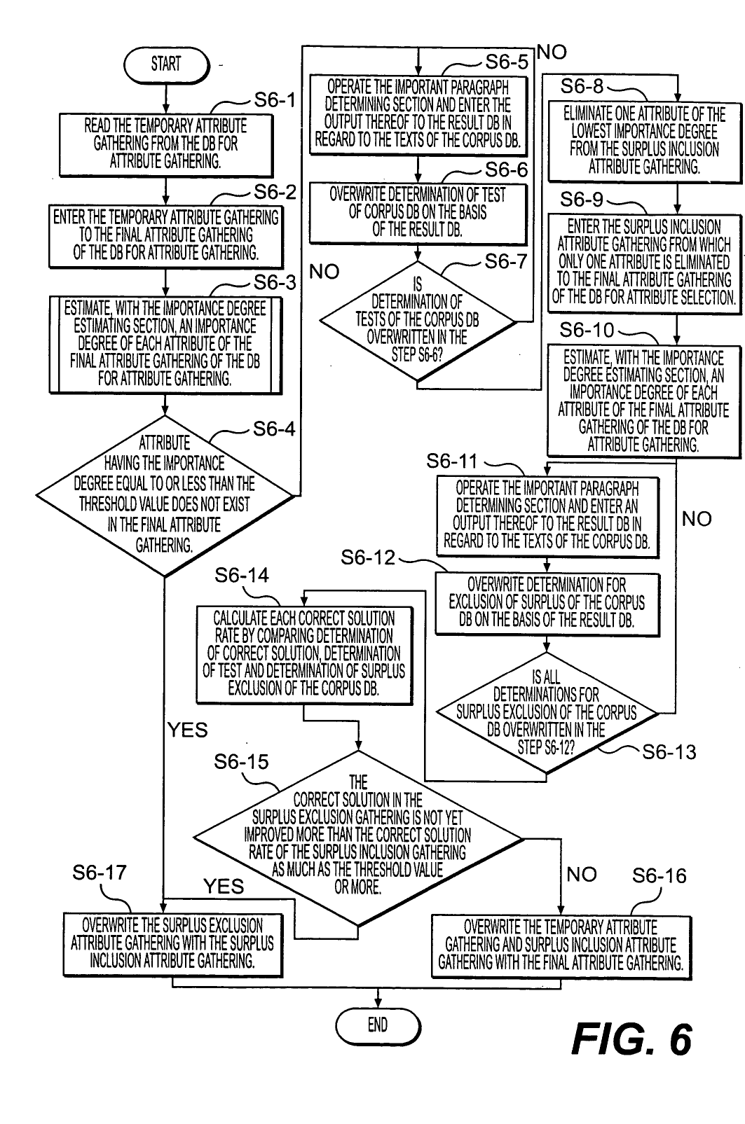

FIG. 6 is a flowchart for describing the process performed by, for example, the surplus attribute deleting section to be executed in step S3-8 of FIG. 3. In the example process, the text information generating apparatus in relation to the embodiment of the present invention reads first temporary attribute set of the DB for attribute set of FIG. 11 (step S6-1). Next, in the disclosed embodiment, the final attribute set is overwritten by the temporary attribute in the DB for attribute set of FIG. 11 (step S6-2). This can be performed in, for example, the text information generating apparatus in relation to the embodiment of the present invention.

Next, there is an estimation of an importance degree of each attribute included in the final attribute set of the DB for attribute set of FIG. 11. This can be performed in, for example, the text information generating apparatus in relation to the embodiment of the present invention together with the importance degree estimating section (step S6-3). Next, in an example of the present invention, the text information generating apparatus in relation to the embodiment of the present invention determines whether attribute having the importance degree equal to or lower than the threshold value exists or does not exist in the final attribute set of the DB for attribute set of FIG. 11 (step S64).

Next, when it is determined in step S6-4 that attribute having the importance degree equal to or lower than the threshold value exists, the text information generating apparatus in relation to the embodiment of the present invention determines an importance degree of each paragraph forming each text of the corpus DB of FIG. 12 with the important paragraph determining section and writes an output to the result DB of FIG. 13 (step S6-5). Then, the determination of test of the corpus DB of FIG. 12 based on the result DB of FIG. 13 is overwritten (step S6-6). Next, it is determined whether the determination of test of all texts of the corpus DB of FIG. 12 is overwritten or not in step S6-6 (step S6-7).

Next, the text information generating apparatus in relation to the embodiment of the present invention, for example, reads each attribute and an importance degree of each attribute from the importance degree DB of FIG. 14, selects attribute having the lowest importance degree, and deletes selected attribute having the lowest importance degree from the surplus attribute set of the DB for attribute set of FIG. 11 (step S68). Here, attribute selected in step S6-8 is not the attribute having a minus importance degree indicating that the paragraph is not important when the selected attribute is included in this paragraph but the attribute having a non-effective importance degree.

The attribute selected in step S6-8 can be defined, for example, as the attribute including, respectively in 50%, the weight that the paragraph is important when attribute is included therein and the weight that the paragraph is not important when attribute is included therein, for example, in an example of the learning method based on the maximum entropy method. Next, the surplus inclusion attribute set is written into the final attribute set in the DB for attribute set of FIG. 11 (step S6-9). This can be performed in, for example, the text information generating apparatus in relation to the embodiment of the present invention.

Next, the text information generating apparatus in relation to the embodiment of the present invention, for example, estimates an importance degree of each attribute forming the final attribute set of the DB for attribute set of FIG. 11 with the importance degree estimating section (step S6-10). Next, the text information generating apparatus in relation to the embodiment of the present invention determines an importance of each paragraph of the corpus DB of FIG. 12 with the important paragraph determining section and writes the result of this determination to the result DB of FIG. 13 (step S6-11).

Next, a determination of surplus exclusion of the corpus DB of FIG. 12 is overwritten based on the result DB of FIG. 13 (step S6-12). Then as shown in the example, it is determined whether all determinations of surplus exclusion of the corpus DB of FIG. 12 are overwritten in step S6-12 or not (step S6-13). When it is determined in step S6-13 that all surplus exclusion determinations of the corpus DB of FIG. 12 are overwritten in step S6-13, a rate 1 is calculated by, for example, comparing the determination of correct solution and determination of test and a rate 2 is calculated by, for example, comparing the determination of correct solution and determination of surplus exclusion of the corpus DB of FIG. 12 (step S6-14). This can be performed in, for example, the text information generating apparatus in relation to the embodiment of the present invention.

Next, in the illustrative example, in the text information generating apparatus in relation to the embodiment of the present invention, rate 3 is calculated by adding the predetermined threshold value to the rate 1, and thereby it is determined when the rate 2 is larger than rate 3.

When it is determined in step S6-15 of the preferred embodiment that the rate 2 is larger than the rate 3, the temporary attribute set, surplus inclusion attribute set and initial attribute set is overwritten with the final attribute set in the DB attribute set of FIG. 11 (step S616). On the other hand, when it is determined in step S6-15 that the rate 2 is not larger than the rate 3, the text information generating apparatus in relation to the embodiment of the present invention, for example, overwrites the surplus exclusion attribute set with the surplus inclusion attribute set before surplus attribute is excluded in the DB for attribute set of FIG. 11 (step S6-17).

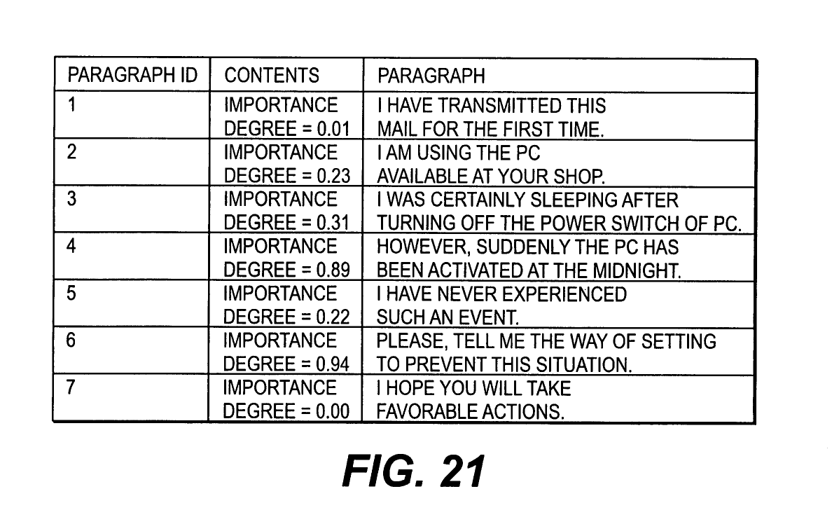

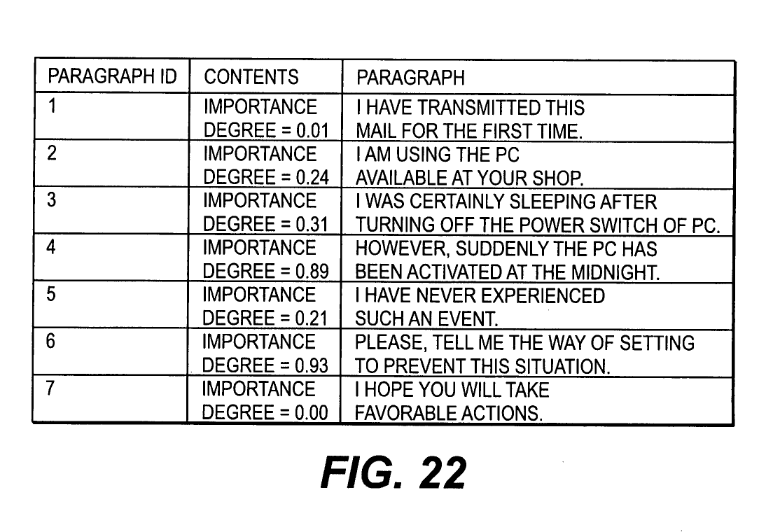

FIG. 21 is a diagram illustrating each paragraph and an importance degree when the text of text ID=2 in the corpus DB is inputted to the importance degree determining device using the surplus inclusion attribute set which is obtained when surplus attribute is not deleted. FIG. 22 is a diagram illustrating each paragraph and an importance degree when the text of text ID=2 in the corpus DB is inputted to the importance degree determining device using the surplus exclusion attribute set which is obtained when surplus attribute is deleted. As can be understood from FIG. 21 and FIG. 22, it is apparent that accuracy is almost equal even when attribute is deleted.

When surplus attribute is deleted as described above, since amount of attributes is reduced even when accuracy is kept almost to the equal level, it is possible to attain the merit that execution velocity when the actual input appears can be improved as described in the lower part of FIG. 2.

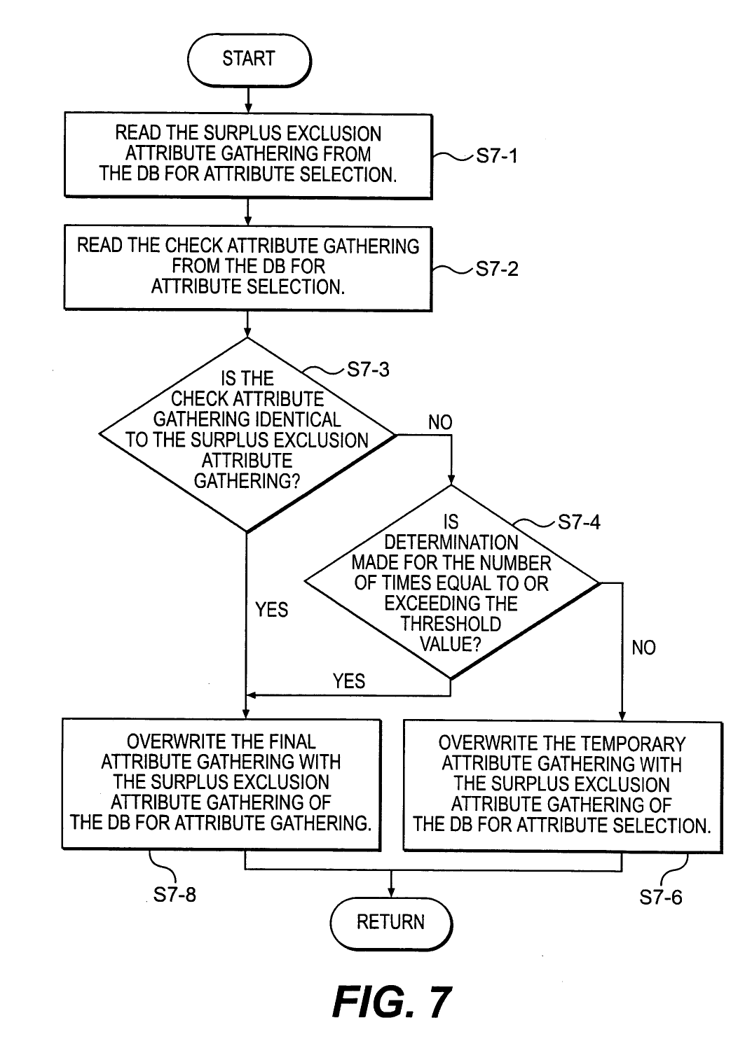

FIG. 7 illustrates a flowchart for describing the final check to be executed in step S3-7 of FIG. 3. For the final check, the surplus exclusion attribute set from the DB for attribute selection of FIG. 11 is read (step S7-1). Next, the check attribute set is read from the DB for attribute selection of FIG. 11 (step S7-2).

Next, it is, in this example, determined whether the check attribute set and surplus exclusion attribute set in the DB for attribute set of FIG. 11 are the same attribute gathers or not (step S7-3). This can be performed in, for example, the text information generating apparatus in relation to the embodiment of the present invention. When it is determined in step S7-3 that these are different attribute sets, it is determined whether determination for different attribute sets has been conducted for the number of times equal to or larger than the threshold value or not (step S7-4). This also can be performed in, for example, the text information generating apparatus in relation to the embodiment of the present invention. When it is determined in step S7-3 that the check attribute set is identical to the surplus exclusion attribute set or it is determined in step S7-4 that determination is made exceeding the threshold value, the final attribute set is overwritten with the surplus exclusion attribute set in, for example, the text information generating apparatus in relation to the embodiment of the present invention (step S7-8).

When it is determined in step S7-4 that determination is made less than the threshold value, the temporary attribute set is overwritten with the surplus exclusion attribute set in, for example, the text information generating apparatus in relation to the embodiment of the present invention (step S7-6).

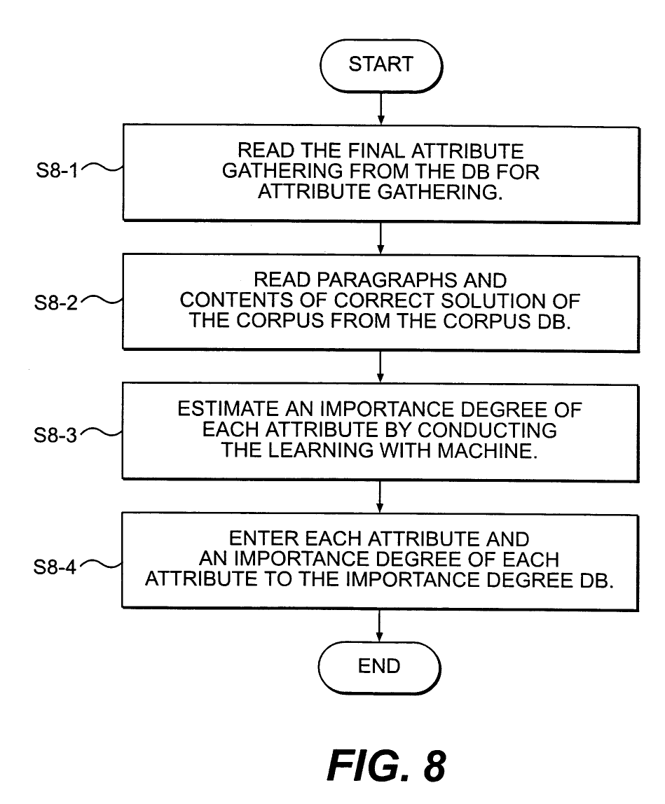

FIG. 8 illustrates a flowchart for describing the process of the importance degree estimating section executed in, for example, step S54 of FIG. 5, step S6-3 and step S6-10 of FIG. 6. As the process of the importance degree estimating section, the text information generating apparatus in relation to the embodiment of the present invention, for example, reads first the final attribute set of the DB for attribute set (step S8-1). Next, each paragraph and contents of each correct solution are read from the corpus DB of FIG. 12 (step S8-2). This can be performed in, for example, the text information generating apparatus in relation to the embodiment of the present invention. Next, in, for example, the text information generating apparatus in relation to the embodiment of the present invention, machine learning is conducted on the basis of the importance degree of each paragraph and contents of each correct solution inputted and thereby an importance degree of each attribute included in the final attribute set of the DB for attribute set of FIG. 11 is estimated (step S8-3).

Next, the data in the DB for importance degree of FIG. 14 are all erased and each attribute of the final attribute set of the DB for attribute set of FIG. 11 and an importance degree of each attribute estimated in step S8-3 are entered to the DB for importance degree of FIG. 14 (step S8-4). This can be performed in, for example, the text information generating apparatus in relation to the embodiment of the present invention.

As the method of machine learning in step S8-3, any method of machine learning can be used under the condition that a numerical value as an importance degree of each attribute or expression indicating a degree can be estimated. For example, there is proposed a method for estimating an importance degree of each attribute by estimating, the weight of each identity function F( ) of each attribute under the supposition that each attribute is formed of a pair of the identity functions {F(important|attribute), F(not important|attribute)} indicating that the paragraph including attribute is important or not important by utilizing the maximum entropy method (“Language and Calculation-4 Language Model with Probability”, Publication Dept. of the Tokyo Univ.; P158) and the iterative scaling method as an internal parameter estimating method of the maximum entropy method (“Language and Calculation-4 Language Model with Probability”, Publication Dept. of the Tokyo Univ.; P163). An example of the formula indicating an importance degree of each attribute is indicated as the formula 1.

exp^{λF(important|attribute)}/(exp^{λiF(important|attribute)}+exp^{λjF(not important|attribute)}) [Formula 1]

Moreover, it is also possible to consider the method for calculating the possibility P (important|attribute) with condition that paragraph is important when it includes attribute from the number of times of appearance of each attribute within the paragraph where contents of corpus are simply considered important and the paragraph where contents of corpus are considered not important.

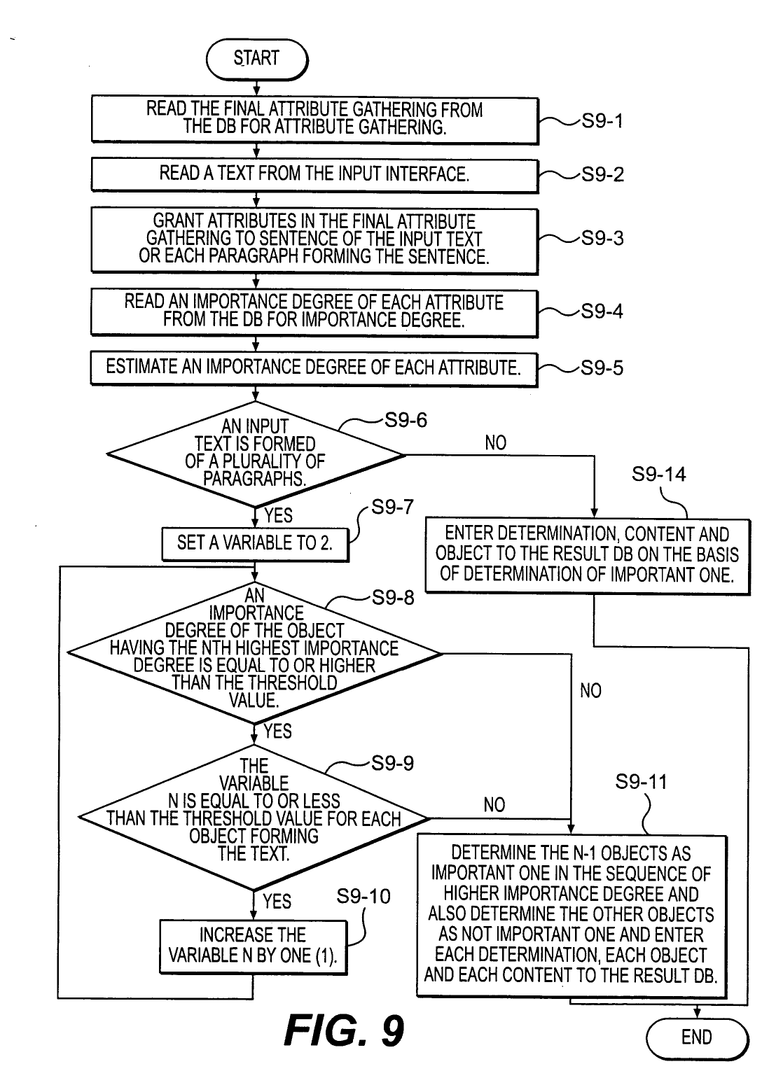

FIG. 9 illustrates a flowchart for describing the process with the important paragraph determining section. In, for example, the process with the important paragraph determining section, the final attribute set is read first from the DB for attribute set of FIG. 11 in the text information generating apparatus in relation to the embodiment of the present invention (step S9-1). Next, a text is read from the text input interface of FIG. 1 in, for example, the text information generating apparatus in relation to the embodiment of the present invention (step S9-2). Next, attributes included in the final attribute set of DB for attribute set of FIG. 11 are granted to the sentence of the input text or to each paragraph forming the sentence (step S9-3). This can be performed in, for example, the text information generating apparatus in relation to the embodiment of the present invention.

Next, an importance degree of each attribute granted from the importance degree DB of FIG. 14 is read by, for example, the text information generating apparatus in relation to the embodiment of the present invention (step S9-4). Next, an importance degree of sentence of the input text or each paragraph forming the sentence is estimated on the basis of the importance degree of each attribute inputted (step S9-5).

In accordance with the present invention, various methods are considered depending on the method of machine learning conducted by the important degree estimating section and profile of the estimated importance degree of each attribute as the method of estimating importance degree of each paragraph. However, for example, following method can be employed as an example of the estimation method in the case where the weights of two identity functions regarding each attribute are estimated with the maximum entropy method described above.

Namely, in the example method, a ratio of the numerical value calculated by multiplying the weight of identity function, from a set of identify functions of each attribute forming the attribute set, indicating that the paragraph is important when each attribute exists in the attribute set to each paragraph and the numerical value calculated by multiplying, to each paragraph, the weight of identify function indicating that the paragraph is not important when each attribute exists in the group of attributes is defined as an importance degree.

Referring to FIG. 9, it is determined whether the text is formed of a plurality of paragraphs or not (step S9-6). Next, when it is determined in step S9-6 that the text is formed of single paragraph, the paragraph is determined as important paragraph and the paragraph and calculated importance degree are written into the result DB of FIG. 14 by, for example, the text information generating apparatus in relation to the embodiment of the present invention (step S9-12).

On the other hand, when the text is determined to be formed of a plurality of paragraphs in step S9-6, a variable N is set to 2 by, for example, the text information generating apparatus in relation to the embodiment of the present invention (step S9-7). Next, when the variable N is equal to the value 2 or larger, it is determined that an importance degree is equal to or larger than the predetermined threshold value or not for the paragraph having the Nth largest importance degree (step S9-8). When the importance degree of the paragraph having the Nth largest importance degree is determined in step S9-8 to be equal to or larger than the threshold value, it is determined whether the variable N is less than the predetermined threshold value determined for each number of paragraphs included in the text or not by, for example, the text information generating apparatus in relation to the embodiment of the present invention (step S9-9).

When the variable N is determined to be less than the predetermined threshold value determined for each number of paragraphs in step S9-9, the text information generating apparatus in relation to the embodiment of the present invention increases the variable N by one (step S9-10) and returns to the step S9-8.

Meanwhile, when the variable N is determined in step S9-9 to be larger than the predetermined threshold value for each number of paragraphs included in the text or when the importance degree is determined to be less than the threshold value in step S9-8, all determinations are set to be not important, thereafter determinations up to the threshold value determined for each number of paragraphs included in the text are changed to be important in the sequence of the higher importance degree, and all determinations, all paragraphs and all contents in the text are entered to the result DB (step S9-11). Namely, in step S9-11, the N−1 paragraphs are determined as important paragraphs in the sequence of higher importance degree, the other paragraphs are determined to be not important, and all determinations, all paragraphs and all contents in the text are entered to the result DB.

According to an embodiment of the text information generating method and apparatus of the present invention, for example, when the text illustrated in FIG. 15 is inputted, an abstract sentence described in FIG. 17 formed of the important paragraph in the text of FIG. 15 (for example, the sentence of about one to three paragraphs summarized from the mail sentence) can be outputted. And, the text described in FIG. 18 wherein the important paragraph in the text of FIG. 15 is displayed with emphasis can also be outputted. In accordance with the present invention, the important paragraph is formed and is displayed, that can be the only paragraph determined and displayed. Other paragraphs may be determined and displayed, by the one determined to be the important paragraph should be noted as such by displaying only that paragraph, or through some other suitable identification of the determined important paragraph.

Accordingly, the job and process which require investigation of similarity of texts such as search and incident clustering can be executed easily by utilizing the information outputted from the text information generating apparatus in relation to the embodiment of the present invention.

The text information generating method and apparatus in relation to the embodiment of the present invention can also be used, for example, in the following illustrative embodiments.

Embodiment 1

Embodiment 1 is an incident clustering apparatus which includes the text information generating method and apparatus in relation to an embodiment of the present invention, which clusters a plurality of incidents that include, for example a predetermined contents to only one gathered on the basis of an abstract sentence outputted from the text information generating apparatus in relation to the embodiment of the present invention.

The incident clustering method and apparatus in relation to the embodiment 1 inputs, when there exist a plurality of texts respectively describing a plurality of examples, these texts to the text information generating apparatus in relation to the embodiment of the present invention and thereby gathers the texts providing similar outputs to only one gathering.

As the method of determining whether an output is similar or not, the method used, for example, in the vector space method (refer to the Reference document: Addison-Wesley Publishing (1989), Automatic Text Processing, pp. 312-325, Salton, G.: The Vector Space Model) can be used, although the present invention is not restricted to such a method.

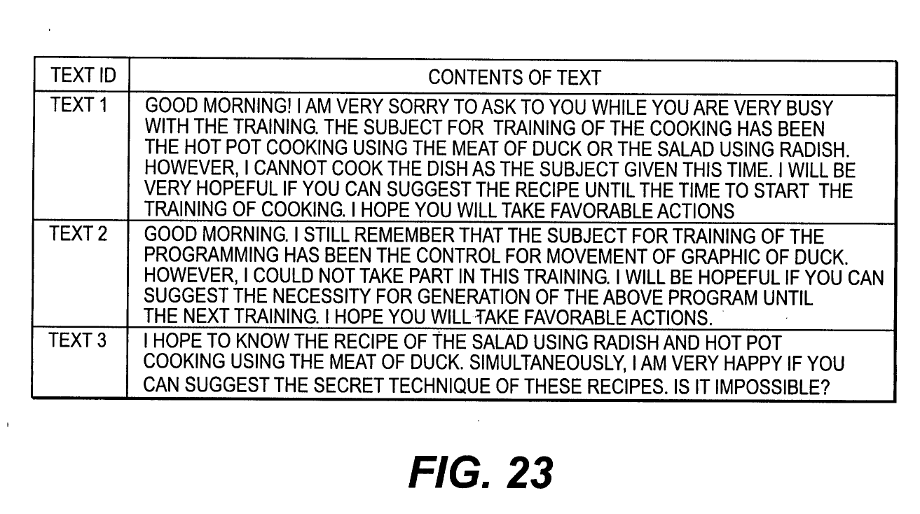

The incident clustering method and apparatus in relation to the embodiment 1 will be described practically using the text 1, text 2 and text 3 of FIG. 23. A direction vector is generated in regard to words within the text based on, for example, the output of the text information generating apparatus in relation to the embodiment of the present invention when the text 1, text 2 and text 3 are inputted and calculates distance between respective vectors using the method of vector space model (the nearest distance is defined here as distance 1 and the longest distance as distance 0 for the convenience of description).

If it is assumed here that the absolute value of the distance between the vectors of the abstract sentence of the text 1 and the abstract sentence of the text 2 is calculated as 0.8 in the incident clustering method and apparatus in relation to the embodiment 1, while the absolute value of the distance between the vectors of the abstract sentence of the text 1 and the abstract sentence of the text 3 is calculated as 0.95 and the absolute value of the distance between the vectors of the abstract sentence of the text 2 and the abstract sentence of the text 3 is calculated as 0.82, the incident clustering method and apparatus in relation to the embodiment 1 determines that the text 1 is more similar to the text 3 than the text 2 and can summarize, when the summarizing threshold value is 0.88, the text 1 and text 3 as the text of the same content into a set of texts but cannot summarize the text 1 and text 2, moreover, the text 2 and text 3 into a set of texts.

Embodiment 2

Embodiment 2 of the text information generating method and apparatus in relation to the embodiment of the present invention is a question example extracting apparatus for generating FAQ (Frequently Asked Questions) including the incident clustering apparatus in relation to the embodiment 1. The question example extracting method and apparatus for generating FAQ in relation to the embodiment 2 gathers examples for the DB storing a plurality of question examples and sorts a plurality of question examples to several gatherings of question examples using the incident clustering apparatus in relation to the embodiment 1.

The question example extracting method and apparatus for generating FAQ in relation to the embodiment 2 determines the gathering of question examples including the question example which are assumed to be asked in the future among each gathering of question examples and outputs the question examples included in the determined gathering of question examples.

As the method for determining the gathering of question examples including the question examples which are assumed to be asked in the future, the method for selecting the gathering of question examples including a large number of texts and the gathering of question examples including the question examples to which the questions have recently been sent frequently can be thought although not particularly described.

As the method for determining the question examples of the gathering of question examples to be outputted, the method for example, in which when the incident clustering method and apparatus described above uses the method of the vector space model, for example, the text itself having the vector indicating the center position in the clustering inputted to this apparatus is used.

For example, when a large amount of texts similar to the three texts described in FIG. 23 exist in the DB and the gathering of texts indicating the center of vector of the abstract sentence of the text 1 actually exists, contents of the text 1 is outputted as the question example for generating FAQ.

Embodiment 3

Embodiment 3 of the text information generating method and apparatus in relation to the embodiment of the present invention relates to a search apparatus which uses, as the search key or search query, all words appearing in the text in which the important paragraphs are displayed with emphasis or in the abstract sentence outputted from the text information generating apparatus in relation to the embodiment of the present invention.

The search method, for example, can be the method in which examples are gathered for the search text as the key text using the incident clustering apparatus in relation to the embodiment 1 and the texts as many as the number determined with a user in the sequence of similarity to the contents of the search text as the key are displayed from the gathering of texts summarized with such clustering of incidents.

In one practical example of the search method and apparatus in relation to the embodiment 3, it is desirable to realize searching of question examples of the text 3, in the case of the search text, for example, using contents of the text 1 of FIG. 23 as the key, which can obtain the abstract sentence similar to that of the text 1 or the abstract sentence including many words such as “training of cooking”, “hot pot cooking of duck”, “vegetables gratin”, “cooking”, “cooking method” and “teach me” or the like included in this abstract sentence.

The search method and apparatus in relation to the embodiment 3 can be effectively used to extract the answer to the question example from the DB where the question examples and answers corresponding to these question examples are described.

As described above, according to the text information generating method and apparatus in relation to the embodiment of the present invention, since the paragraph in relation to contents of text can be extracted from the text, contents of text can be understood easily on the occasion of search and clustering of incidents and accuracy of search and clustering of incidents can be enhanced.

Moreover, according to the text information generating method and apparatus in relation to the embodiment of the present invention, accuracy of search and clustering of incidents can be improved even for the text which cannot emphasize the similarity of contents even when only the result of discourse structure analysis is simply used because the corpus is used. Namely, the text information generating method and apparatus in relation to the embodiment of the present invention can improve the accuracy of search and clustering of incidents even when such search and clustering of incidents are performed using the text which has failed the discourse structure analysis because the method and apparatus can find one or more texts if one or more texts cannot emphasize the similarity of context in the corpus and used attributes were not only discourse structure attributes but also characters of words included in one or more funded texts.

Moreover, as described above in Japanese Published Unexamined Patent Application No. 2002-24144, in order to generate a template, a format of template and conversion rule to the template from text or paragraph must be generated by manually detecting, after generation of the corpus or the table of the same kind, the feature in the format of the text itself and the feature in the format of the paragraph having higher importance degree included in the generated corpus or the table of the same kind. However, according to the text information generating apparatus in relation to the embodiment of the present invention, only generation of the corpus and discourse structure analysis rule is required.

Therefore, according to the text information generating method and apparatus in relation to the embodiment of the present invention, the required cost is not increased even in the comparison with the method to generate a template even when the cost required for generation of discourse structure analysis rule is considered. in addition, according to the text information generating method and apparatus in relation to the embodiment of the present invention, the discourse structure analysis rule can be applied to the texts in any fields so long as the texts have the similar expression at the end of sentences and totally, the cost can be reduced more than that in the method of generating the template.

Also, according to the text information generating method and apparatus in relation to the embodiment of the present invention, execution of abstract sentence can be realized even when the amount corpus is rather small and discourse structure analysis has failed, and the present invention is superior, in this point, to the method for generating the template. As described above, according to the present invention, the paragraphs which are intensively related to contents of texts can be extracted from the texts without requirement of costs used for a large amount of man-power and the information of texts can be generated using the extracted paragraphs.

Therefore, according to the present invention, the information for finding out the texts having similar contents can be generated easily during the jobs or processes which require investigation of similarity of the texts such as the search of text and clustering of incidents.

What is claimed is:

1. A text information generating apparatus, comprising:
attribute input section operatively connected to receive at least one artificial attribute associated with a paragraph;
discourse structure attribute generating section operatively connected to generate a discourse structure attribute related to a discourse structure that is associated with said paragraph and a paragraph length ratio attribute related to a ratio of a number of characters in said paragraph to the number of characters of a matching pattern matched with said paragraph;
combination attribute generating section operatively connected to generate a combination attribute based on at least two of the artificial attribute, the discourse structure attribute, and the paragraph length ratio attribute;
text input interface operatively connected to receive text;
importance degree estimating section operatively connected to estimate an importance degree indicating an enhancement degree of correlation between said paragraph and the text based on at least one of the artificial attribute, the discourse structure attribute, the paragraph length ratio, and the combination attribute;
important paragraph determining section operatively connected to determine an important paragraph having higher correlation with the text based on the estimated importance degree of each attribute from one or more paragraphs in the text; and
text output interface operatively connect to provide information of the text that is based on the determination of said important paragraph determining section.

2. A text information generating apparatus comprising:
attribute input section operatively connected to receive at least one artificial attribute that is associated with a paragraph;
discourse structure attribute generating section operatively connected to generate a discourse structure attribute related to a discourse structure and associated with said paragraph and a paragraph length attribute related to a ratio of a number of characters of said paragraph to a number of characters of a matching pattern matched to said paragraph;
word attribute generating section operatively connected to generate word attribute related to words of said paragraph;
combination attribute generating section operatively connected to generate a combination attribute based on at least two of the artificial attribute, the discourse structure attribute, the paragraph length ratio attribute, and the word attribute;
text input interface operatively connected to receive text;
importance degree estimating section operatively connected to estimate an importance degree indicating an enhancement degree of correlation between said paragraph and the text based on at least one of the artificial attribute, the discourse structure attribute, the paragraph length ratio attribute, the word attribute, and the combination attribute;
important paragraph determining section operatively connected to determine, based on the estimated importance degree of each attribute, an important paragraph having a higher correlation with the text from one or more paragraphs in the text; and
text output interface operatively connected to provide information of the text that is based on the determination of said important paragraph determining section.

3. A text information generating apparatus comprising:
attribute input section operatively connected to receive at least one artificial attribute that is associated with a paragraph;
discourse structure attribute generating section operatively connected to generate a discourse structure attribute related to a discourse structure that may be associated with said paragraph and a paragraph length ratio attribute related to a ratio of a number of characters in said paragraph to the number of characters of a matching pattern matched with said paragraph;
combination attribute generating section operatively connected to generate a combination attribute based on at least two of the artificial attribute, the discourse structure attribute, and the paragraph length ratio attribute;
text input interface operatively connected to receive text;
importance degree estimating section operatively connected to estimate an importance degree indicating an enhancement degree of correlation between said paragraph and the text based on at least one of the artificial attribute, the discourse structure attribute, the paragraph length ratio, and the combination attribute, and to determine at least one surplus attribute from at least two of the artificial attribute, the discourse structure attribute, the paragraph length ratio, and the combination attribute;
surplus attribute deleting section operatively connected to delete the determined surplus attribute from the attributes utilized by said importance degree estimating section;
important paragraph determining section operatively connected to determine, from one or more paragraphs, an important paragraph having higher correlation with contents of text based on the estimated importance degree of the attribute not determined to be a surplus attribute; and
text output interface operatively connected to provide information of the text based on the determination of said important paragraph determining section.

4. The text information generating apparatus according to claim 1, wherein information of text outputted from said text output interface includes an abstract sentence based on the paragraph determined as the important paragraph.

5. An example gathering apparatus comprising the text information generating apparatus according to claim 1, wherein an incident clustering section makes one set of text from a plurality of texts using text information provided by the text information generating apparatus above.

6. A question example extracting apparatus for generating frequent text comprising the incident clustering apparatus according to claim 5;
a sorting section operatively connected to sort a plurality of question based on the gathered text; and
a determining section operatively connected to estimate frequent test based on at least some of the sorted plurality of questions.

7. A searching apparatus comprising the text information generating apparatus according to claim 1; and
a searching section operatively connected to search for predetermined contents in text based on the information of the text.

8. A text information generating method, comprising:
receiving at least one artificial attribute and is associated with a paragraph;
generating a discourse structure attribute related to a discourse structure that is associated with said paragraph and a paragraph length ratio attribute related to a ratio of a number of characters in said paragraph to the number of characters of a matching pattern matched with said paragraph;
generating a combination attribute based on at least two of the artificial attribute, the discourse structure attribute, and the paragraph length ratio attribute;
receiving text;
estimating an importance degree indicating an enhancement degree of correlation between said paragraph and the text based on at least one of the artificial attribute, the discourse structure attribute, the paragraph length ratio, and the combination attribute;
determining an important paragraph having higher correlation with the text based on the estimated importance degree of each attribute from one or more paragraphs in the text; and
providing information of the text that is based on the determining.

9. A text information generating method comprising:
receiving at least one artificial attribute that is associated with a paragraph;
generating a discourse structure attribute related to a discourse structure and associated with said paragraph and a paragraph length attribute related to a ratio of a number of characters of said paragraph to a number of characters of a matching pattern matched to said paragraph;
generating a word attribute related to words of said paragraph;
generating a combination attribute based on at least two of the artificial attribute, the discourse structure attribute, the paragraph length ratio attribute, and the word attribute;
receiving text;
estimating an importance degree indicating an enhancement degree of correlation between said paragraph and the text based on at least one of the artificial attribute, the discourse structure attribute, the paragraph length ratio attribute, the word attribute, and the combination attribute;
determining, based on the estimated importance degree of each attribute, an important paragraph having a higher correlation with the text from one or more paragraphs in the text; and
providing information of the text that is based on the determination of said important paragraph determining section.

10. A text information generating method comprising:
receiving at least one artificial attribute that is associated with a paragraph;
generating a discourse structure attribute related to a discourse structure that may be associated with said paragraph and a paragraph length ratio attribute related to a ratio of a number of characters in said paragraph to the number of characters of a matching pattern matched with said paragraph;
generating a combination attribute based on at least two of the artificial attribute, the discourse structure attribute, and the paragraph length ratio attribute;
receiving text;
estimating an importance degree indicating an enhancement degree of correlation between said paragraph and the text based on at least one of the artificial attribute, the discourse structure attribute, the paragraph length ratio, and the combination attribute, and to determine at least one surplus attribute from at least two of the artificial attribute, the discourse structure attribute, the paragraph length ratio, and the combination attribute;
deleting the determined surplus attribute from the attributes utilized in the estimation;
determining, from one or more paragraphs, an important paragraph having higher correlation with contents of text based on the estimated importance degree of the attribute not determined to be a surplus attribute; and
providing information of the text based on the determining of said important paragraph.
